(19) United States
(12) Patent Application Publication
(10) Pub. No.: US 2015/0106323 A1
(43) Pub. Date: Apr. 16, 2015

(54) PSOAF System Parameter Estimator (PSOAF)

(71) Applicant: Abeeb Adebowale Awotunde, Lagos (NG)

(72) Inventor: Abeeb Adebowale Awotunde, Lagos (NG)

(21) Appl. No.: 14/051,152

(22) Filed: Oct. 10, 2013

(51) Int. Cl. G06N 7/00

(52) U.S. Cl. CPC G06N 7/00
USPC 706/52

(57) ABSTRACT

The PSOAF System Parameter-Estimator, called herein the PSOAF, is an optimizer designed to estimate the unknown parameters or the optimal parameters of a system. PSOAF stands for Particle Swarm Optimizer with Averaging Filter. The optimizer uses the intelligent behaviors of particles in a swarm and an averaging filter to estimate the parameters of a system. The parameters referred to here can be the unknown parameters of a system (e.g. permeability distribution in a hydrocarbon reservoir) or the optimum parameters of a system (e.g. the optimal locations of wells in a reservoir, the optimum controls of such wells, or the optimum operating parameters of any system in any field). The averaging filter in the PSOAF serves to discriminate among the particles in order to determine which of the particles are most important. Particles identified as important by the filtering procedure are evaluated while other particles are not evaluated but assigned the fitness of their representative average.

### BACKGROUND OF INVENTION

1. Field of the Invention

This invention relates to the estimation of system parameters, otherwise known as optimization. It can be used in many fields of human endeavor to estimate either the unknown parameters of a system or the optimal parameters to impose on a system to achieve the best results. It has been specifically utilized in the field of Petroleum Engineering in (1) estimating the unknown permeability distribution and other reservoir parameters (including the reservoir porosity, the rock compressibility and the parameters of the relative permeability curves) of a petroleum reservoir (2) determining the optimum positions of wells and the optimum controls to impose on the wells during the primary and secondary depletion of a petroleum reservoir.

2. Description of Related Art

The Particle Swarm Optimizer (PSO), developed by James Kennedy and Russel Eberhart (Kennedy and Eberhart 1995), is one of the optimization tools that are useful in the estimation of system parameters. The PSO is a stochastic search optimizer built upon the movement of particles in a multidimensional problem space. The position of each particle represents one solution of the problem. The solution is evaluated by an objective function that gives an indication of the optimality of that solution. The optimizer is designed in such a way that particles move away from suboptimal positions towards optimal ones. This movement of particles is influenced by the best position previously found by each particle and the best position found so far by any particle in the swarm. When a particle moves to a new location, a different solution is generated and its fitness is evaluated.

Consider that each particle, \vec{x}ⱼ=[x₁ⱼ x₂ⱼ x₃ⱼ . . . x_{Mj}]^{T}, in a swarm of size J, consists of M elements, each element representing one of the parameters to be optimized. In the basic PSO optimizer, the position of each particle is updated, iteratively by:

\vec{x}ⱼ^{κ+1}=\vec{x}ⱼ^{κ}+\vec{v}ⱼ^{k}, (1)

where \vec{v}ⱼ^{k} is the velocity of the particle \vec{x}ⱼ at the κ^{th} iteration. \vec{v}ⱼ^{k} is given by:

\vec{v}ⱼ^{κ+1}=w\vec{v}ⱼ^{κ}+c₁r₁(\vec{x}ₚ_{ⱼ}^{κ}−\vec{x}ⱼ^{κ})+c₂r₂(\vec{x}_{g}^{κ}−\vec{x}ⱼ^{κ}). (₂)

In Eq. (2), \vec{x}ₚ_{ⱼ}^{κ} is the best position ever visited by particle \vec{x}ⱼ^{κ}, \vec{x}_{g}^{κ} is the best position ever visited by any particle in the swarm, w is the inertial factor that controls the trade-off between the local and global exploration capabilities of the swarm. c₁ and c₂ are the cognitive and social parameters that control the extent to which particles are drawn to their ‘personal best’ and the swarm's ‘global best’ positions respectively. r₁ and r₁ are uniformly generated random numbers. At the start of the iteration, each particle is randomly initialized in the interval containing the lower and upper bounds of particle values. These bounds are assumed known and particles' positions are not allowed to fall outside the bounds.

### SUMMARY OF INVENTION

The invention relates to system optimization using a new optimizer named PSOAF. The PSOAF was developed by modifying the behavior of the standard PSO with an averaging filter. The PSOAF provides an efficient means of finding the unknown parameters of a system when the response of the system is provided. This optimizer also has the capability to determine the optimum operating parameters of a system. In the case of estimating the unknown parameters of the system, some response of the system, in the form of measured data, must be provided along with a system simulator, to the PSOAF optimizer. The system simulator, which simulates the response of the system under certain conditions, is connected to the PSOAF. The PSOAF then estimates the parameters of the system that must have produced such response from the system. In the case of determining the optimum operating parameters of a system, the PSOAF only needs to be connected to the system simulator. The PSOAF optimizer then finds the best set of parameters to which the system must be operated to achieve the best results.

### BRIEF DESCRIPTION OF DRAWINGS

FIG. 1 is a flowchart showing the PSOAF procedure. It demonstrates how the averaging filter is used to identify near-optimal subswarms from the suboptimal ones. It also shows how the optimizer avoids the evaluation of the fitness of several particles in the swarm. In FIG. 1, The PSAOF connects to the System Response Simulator (See FIG. 3) whenever the fitness of the particles is to be evaluated.

FIG. 2 is a flowchart that demonstrates the working mechanism of the low-dimensional perturbation algorithm. It illustrates how the low-dimensional perturbation algorithm disperses the particle if the particles come too close to each other before reaching the end of the optimization process.

In FIG. 2, (a) Dpert is the number of coordinates to be perturbed in addition to the current coordinate m, (b) Y is a matrix whose columns represent the particles in the population (c) x is a vector that represents each particle in the population.

FIG. 3 illustrates how the PSOAF System Parameter Estimator interacts with the System Response simulator which must be supplied by the user and connected to the PSOAF.

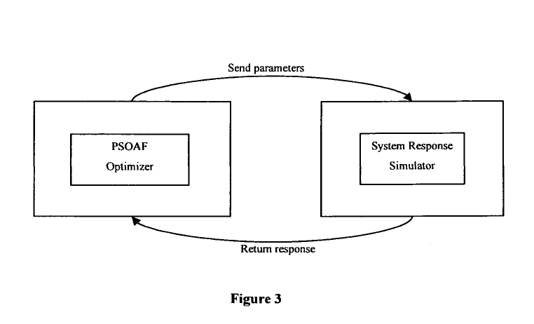

### DETAILED DESCRIPTION OF THE INVENTION

The Philosophy of the PSOAF Optimizer

The most time consuming part of the PSO (Kennedy and Eberhart 1995) is the evaluation of the fitness function (the forward model). Yet, the only use of the fitness values that are obtained from this forward solve is to identify the particles' personal best positions as well as the swarm's overall best position. Thus, a computationally efficient optimizer is that which can find these positions without evaluating the fitness of all particles in the swarm. In this work, we devise a method that searches for the global best particle without evaluating the fitness of all the particles in the swarm. In addition, we compute the fitness of all particles that are identified as having a higher probability of being optimal. The fitness values of particles that are identified as having a higher probability of being suboptimal are not evaluated. Such particles are assigned the fitness values computed for some other representative particles.

The optimizer uses a similarity measure to group particles into subswarms. The particles in any subswarm are then averaged to obtain the subswarm average. All subswarm averages are evaluated and the subswarms with the best fitness ‘average’ values are identified and termed the near-optimal subswarms. All the particles in the near-optimal subswarms are then evaluated individually to identify the global best particle for the current generation. Thus, the approach is premised on the expectation that the subswarms with the best average particles will most likely contain the global best particle. This is often true if the similarity measure adopted is indeed able to cluster similar particles in the same subswarm. The reason for selecting more than one best subswarm is that there are often multiple local minima and the average of the particles in the subswarm containing the global best particle may not necessarily give the best fitness value among all subswarm averages. Because, there is no guarantee that the global best particle is found amongst the selected near-optimal subswarms, the particle identified as the best is termed a pseudo-global best particle. The particles in other subswarms (termed as suboptimal subswarms) are not evaluated individually. Rather, such particles are assigned the fitness values of their subswarm average. This is intuitive because if a subswarm average is truly representative of all the particles in that subswarm, then its fitness value should be close to the fitness values of those particles. Tracking the exact fitness values of particles in a PSO optimizer is actually irrelevant. What is important is identifying the best particle in the population and the personal best position ever visited by each particle. Thus, the fitness value of a subswarm average can be taken to be the fitness values of the particles in that particular subswarm. Once the pseudo-global best particle is identified, the velocity is computed as:

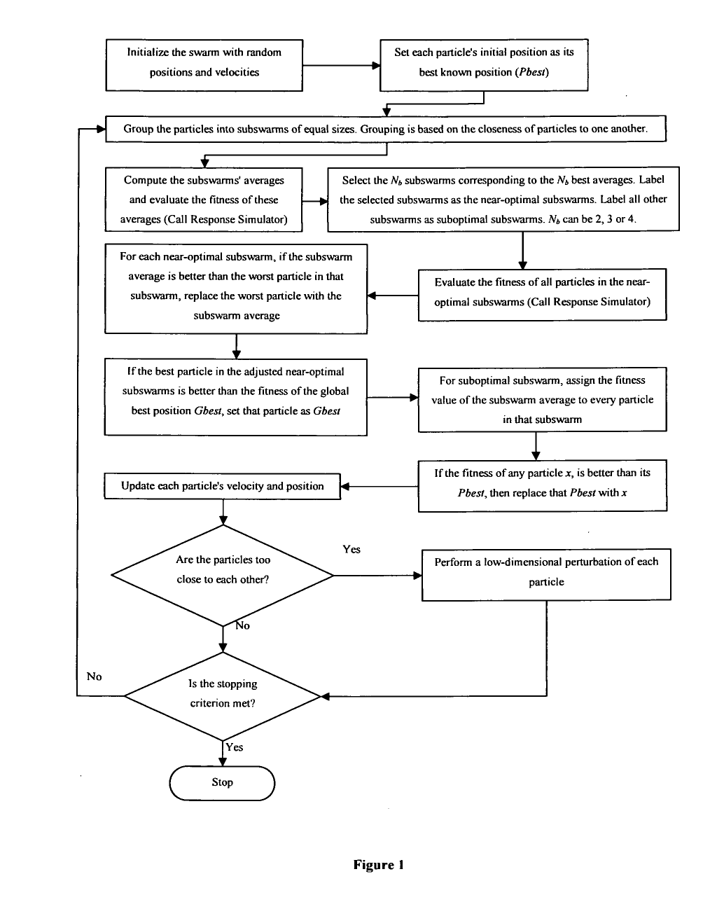

\vec{v}ⱼ^{κ+1}=ω\vec{v}ⱼ^{κ}+c₁r₁(\vec{x}ₚ_{ⱼ}^{κ}−\vec{x}ⱼ^{κ})+c₂r₂(\vec{x}_{g}^{κ}−\vec{x}ⱼ^{κ}), (6)

where \vec{x}_{ġ}^{κ} is the pseudo-global best particle. The PSOAF optimizer in FIG. 1 can be summarized as:

1. Set the PSOAF parameters: w, c₁ and c₂.

2. Initialize particles with random positions and velocities.

3. Using the I₂ or cosine similarity measure, group the population into subswarms.

4. Compute the subswarm averages.

5. Evaluate the fitness of subswarm averages.

6. Select the N_{b} (N_{b}=2, 3 or 4) best subswarms. We refer to the selected subswarms as near-optimal and all other subswarms as suboptimal.

7. Evaluate the fitness of the particles in all the near-optimal subswarms.

8. In each near-optimal subswarm compare the subswarm average to the worst particle. If the subswarm average has a better fitness, replace the worst particle in that subswarm with the subswarm average.

9. For each of the suboptimal subswarms, assign the fitness value of the subswarm average to every particle in that subswarm. Notice that the particles in the suboptimal subswarms are not evaluated individually. Those particles take the fitness values of their respective subswarm averages. These values are already computed in Step 4.

10. Select the global best particle for the current generation. This is the particle with the best fitness value in the whole swarm.

11. Set particles' personal bests to their current positions (only for the first iteration).

12. Evaluate particles' velocities from Equation (6).

13. Update particles' positions using Equation (1).

14. Repeat Steps 4 to 9.

15. Update particles' personal best positions: if fⱼ^{κ}<fₚ_{ⱼ}^{κ} then fₚ_{ⱼ}^{κ} fⱼ^{κ} and \vec{x}ₚ_{ⱼ}^{κ}=\vec{x}ⱼ^{κ}.

16. Update the pseudo-global best position: if fⱼ^{κ}<f_{ġ} then f_{ġ} fⱼ^{κ} and \vec{x}_{ġ}=\vec{x}ⱼ^{κ}.

17. Evaluate particles' velocities from Equation (6).

18. Update particles' positions using Equation (1).

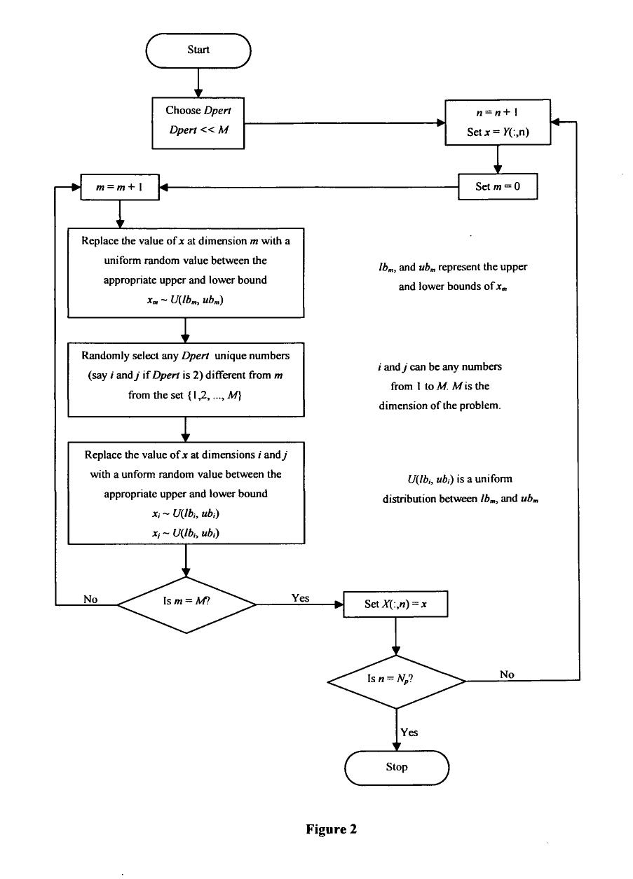

19. If particles are to close to each other disperse the particles using the algorithm in FIG. 2, otherwise move to the next step.

20. Repeat Steps 14 to 19 until the stopping criteria are met.

In Step 15,

fⱼ^{κ}(\vec{x}ⱼ^{κ}), (7)

and:

f_{ġ}=f(x_{ġ}). (8)

We note that in Step 8, the worst particle in any near-optimal subswarm is replaced by the subswarm average if that average has a better fitness value. This means that in many cases the subswarm averages become part of the swarm to be evaluated. In fact, in some cases, a subswarm average may be the global best particle.

The major difference between this optimizer and the standard PSO is that, in the standard PSO, the fitness values of all particles are evaluated, while in the PSOAF, only the fitness values of subswarm averages and those of the particles belonging to the near-optimal subswarms are evaluated. The fitness values of subswarm averages of suboptimal subswarms are readily assigned to particles in their respective subswarms. Thus, the number of function evaluations needed by PSOAF is smaller than that required by PSO. Because the subswarms contain the same number of particles, the number of particles to be evaluated in each generation is given by:

$${N}_{fe} = \frac{{N}_{p}}{{N}_{ps}} + {N}_{b} \times {N}_{ps} , \qquad ( 9 )$$

where N_{fe} is the number of function evaluations per iteration, Nₚ is the total number of particles in the entire swarm, Nₚₛ is the number of particles in each subswarm and N_{b} is the number of near-optimal subswarms.

Averaging of Particles

As described in the previous section, particles are grouped into subswarms and subswarm averages are computed from particles in the subswarms. Computing the subswarm averages is as important as grouping the particles into subswarms. Different averaging procedures are used for the two similarity measures used in this work. Arithmetic mean is used to compute the average of vectors grouped together based on the Euclidian distance. That is, given a set of vectors {\vec{x}₁, \vec{x}₂, . . . ,x_{N}_{ₚₛ}} belonging to the same subswarm, the subswarm average is given by

$${{x}^{->}}_{avg} = \frac{{{x}^{->}}_{1} + {{x}^{->}}_{2} + … + {{x}^{->}}_{{N}_{ps}}}{{N}_{ps}} . \qquad ( 10 )$$

The definition of average in Eq. (10) applies to any subswarm formed based on the Euclidean norm. To compute the subswarm average of particles grouped together based on the cosine measure, first we note that in this case, we deal with directional data (the normalized form of each particle). Thus the mean vector is the vector whose direction is the mean direction of all the directional data. The mean direction is equivalent to the dominant eigenvector of the covariance matrix formed by all the particles in the subswarm. Consider the set of column vectors {\vec{x}₁, \vec{x}₂, . . . , \vec{x}_{N}_{ₚₛ}} belonging to a particular subswarm. A matrix x whose rows are the transposes of the particles in {\vec{x}₁, \vec{x}₂, . . . , \vec{x}_{N}_{ₚₛ}} can be written as

$$X = \{ \begin{matrix}{{x}^{->}}_{1}^{T} \\ {{x}^{->}}_{2}^{T} \\ ⋮ \\ ⋮ \\ {{x}^{->}}_{{N}_{ps}}\end{matrix} \} , \qquad ( 11 )$$

and a covariance matrix C can be formed by

C=X^{T}X. (12)

Then, the (normalized) dominant eigenvector of C, is the mean direction of the particles (vectors) that constitute the rows of X. We denote the normalized dominant eigenvector of C by \vec{λ}_{d} and approximate the average of the particles in the set {\vec{x}₁, \vec{x}₂, . . . , \vec{x}_{N}_{ₚₛ}} by

\vec{x}_{avg}=||\vec{x}||_{avg}*\vec{λ}_{d} (13)

where ||\vec{x}||_{avg} is the mean of the I₂-norms of the vectors in the set {\vec{x}₁, \vec{x}₂, . . . , \vec{x}_{N}_{ₚₛ}}. That is,

$${‖ {x}^{->} ‖}_{avg} = \frac{‖ {{x}^{->}}_{1} ‖ + ‖ {{x}^{->}}_{2} ‖ + … + ‖ {{x}^{->}}_{3} ‖}{{N}_{ps}} . \qquad ( 14 )$$

Thus Equation (13) is used to compute the average of particles grouped together by the cosine similarity measure.

### References

Kennedy, J., Eberhart, R. C. 1995. Particle Swarm Optimization. IEEE International Conference on Neural Networks IV, Piscataway, pp. 1942-1948.

1. A system parameter estimator (the PSOAF) comprising the standard PSO, an averaging filter that modifies the behavior of the standard PSO and a low-dimensional perturbation algorithm that disperses the particles in the swarm when they converge to a common point.

2. The PSOAF of claim 1, wherein the averaging filter groups particles into subswarms and uses the fitness of the subswarm averages to identify near-optimal subswarms and suboptimal subswarms.

3. The PSOAF according to claim 2, wherein, upon identification of the near-optimal subswarms, the PSOAF evaluates the fitness of all particles in the suboptimal subswarm to identify the overall best particle.

4. The PSOAF according to claim 3, wherein the PSOAF replaces the worst particle in each near-optimal subswarm by the subswarm average if the subswarm average is better in performance than that worst particle.

5. The PSOAF of claim 1, wherein the PSOAF saves computational time by assigning the fitness of the subswarm averages of suboptimal subswarms to the particles in the respective suboptimal subswarms.

6. The PSOAF of claim 1, wherein the PSOAF moves the particles around in the search space until optimal system parameters are found.

7. The PSOAF of claim 1, wherein The PSOAF utilizes the low-dimensional perturbation algorithm to disperse the particles in the swarm whenever they come too close to one another, thus preventing premature convergence of the optimizer to a suboptimal solution.

8. The PSOAF of claim 1, wherein, acting in the above stated manner, the PSOAF has the capability to estimate the optimum parameters of any system in a stochastic way subject to the amount of computational resources provided to this optimizer.
